(19) United States
(12) Patent Application Publication
(10) Pub. No.: US 2022/0015332 A1
(43) Pub. Date: Jan. 20, 2022

(54) Protective Collar Attachment System

(71) Applicant: That, But Better LLC, San Diego, CA (US)

(72) Inventor: Kyla Stewart, San Diego, CA (US)

(21) Appl. No.: 17/378,627

(22) Filed: Jul. 16, 2021

Related U.S. Application Data
(60) Provisional application No. 63/052,818, filed on Jul. 16, 2020.

(51) Int. Cl. A01K 13/00; A01K 27/00

(52) U.S. Cl. CPC A01K 13/006; A01K 27/001

(57) ABSTRACT

A protective collar attachment system in which a protective collar is attached to a collar attachment suit. The protective collar has a cone shape similar to an Elizabethan collar and removably attaches to the collar attachment suit. The protective collar is secured to the collar attachment suit by a fastener that prevents the animal from removing the collar, but allows the collar to be removed by a human caretaker. The collar attachment suit includes a vest with apertures for an animal's front limbs. By securing the protective collar to the protective attachment suit, the animal is unable to remove the protective collar. A caretaker can remove and replace the protective collar by engaging the fasteners that secure the protective collar to the collar attachment suit. Thus, the protective collar can easily be temporarily removed to facilitate eating by the animal, medical treatment, or for other purposes.

### RELATED APPLICATION

This application claims priority to U.S. Provisional Patent Application Ser. No. 63/052,818 for a “Protective Collar Attachment System,” filed Jul. 16, 2020, and currently co-pending, the entirety of which is incorporated herein by reference.

### FIELD OF THE INVENTION

The present invention pertains generally to apparatus for use in animal healthcare. More particularly, the present invention pertains to a protective collar with an attachment for securing the protective collar to an animal. The Present invention is particularly, but not exclusively, useful as a pet post-surgery protective apparatus.

### BACKGROUND OF THE INVENTION

Protective collars for animals, known as Elizabethan collars, or colloquially as “cones of shame,” were initially described in U.S. Pat. No. 3,036,554, issued to Frank L. Johnson on May 29, 1962. An Elizabethan collar is a protective collar for an animal, often a dog, fastened around the animal's neck and extending forward at least partly around the animal's head. The Elizabethan collar thus prevents the animal from self-injury caused by biting itself.

An Elizabethan collar is often used to prevent an animal from biting at an injury or surgical stitches on its body, or from scratching an injury on its head. Thus, it is common for an animal to wear an Elizabethan collar for a period of time after surgery, or while recovering from an injury.

Although an Elizabethan collar can be effective at preventing certain types of self-injury while worn, some animals, including some smaller-sized dogs, find ways to remove the collar, hindering its effectiveness. Indeed, when used with a small dog having a relatively small head diameter, or with animals having a low head circumference to neck circumference ratio, removal is common.

Some animals display negative behaviors while wearing an Elizabethan collar, such as not eating, which results in the need to remove the collar temporarily. For example, it may be necessary to remove the collar at mealtimes in order for an animal to eat.

In light of the above, it would be advantageous to provide a protective collar that can be secured to an animal in such a way that the animal cannot remove the collar. It would be further advantageous to provide a protective collar that cannot be removed by the animal, but has a convenient removal and reattachment mechanism for human caretakers.

### SUMMARY OF THE INVENTION

Disclosed is a protective collar attachment system in which a protective collar is attached to a collar attachment garment. In preferred embodiments, the protective collar has a cone shape similar to an Elizabethan collar and removably attaches to the collar attachment garment so as to extend outward partially or fully covering an animal's head. The protective collar is secured to the collar attachment garment by a fastener that prevents the animal from removing the collar, but allows the collar to be removed by a human caretaker.

A preferred embodiment of the collar attachment garment includes a vest with apertures for an animal's front legs or arms. By passing the front or upper limbs of the animal through the collar attachment garment and securing the protective collar to the attachment garment, the animal is unable to remove the protective collar. A caretaker, however, can remove and replace the protective collar by engaging the fasteners that secure the protective collar to the collar attachment garment. Thus, the protective collar can easily be temporarily removed to facilitate eating by the animal, medical treatment, or for other purposes.

Traditional Elizabethan collars are secured either directly around an animal's neck or to a pet collar secured directly around an animal's neck. Since the disclosed protective collar secures to a collar attachment garment rather than directly to an animal's neck, the animal's comfort is improved through use of the protective collar attachment system, resulting in fewer behavioral problems associated with the collar. Moreover, since the collar can be easily removed and replaced by engaging a fastener, temporary removal of the collar for activities such as eating is simplified.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which;

FIG. 1 is a right side view of a preferred embodiment of a protective collar attachment system, showing the protective collar and attachment garment in use with a dog;

FIG. 2 is a top perspective view of the protective collar attachment system of FIG. 1, showing the protective collar and attachment garment;

FIG. 3 is a top perspective view of a fastener of the protective collar attachment system of FIG. 1, the fastener joining the protective collar to the attachment garment;

FIG. 4 is a bottom perspective view of the protective collar attachment system of FIG. 1, showing the armholes of the attachment garment;

FIG. 5 is a bottom perspective view of the fastener of FIG. 3;

FIG. 6 is a front view of the protective collar attachment system of FIG. 1;

FIG. 7 is a top perspective view of the protective collar of the protective collar attachment system of FIG. 1; and

FIG. 8 is a right side view of an alternate preferred embodiment of a protective collar attachment system, showing the protective collar and attachment garment in use with a dog;

FIG. 9 is a top perspective view of the protective collar attachment system of FIG. 8, showing the protective collar and attachment garment;

FIG. 10 is a bottom perspective view of an alternate preferred embodiment of a protective collar attachment system, showing the armholes of the attachment garment;

FIG. 11 is a top view of layout diagram an alternate preferred embodiment of a protective collar attachment system in an unassembled configuration; and

FIG. 12 is a top perspective view of the protective collar attachment system of FIG. 11 in a fully assembled configuration.

### DETAILED DESCRIPTION

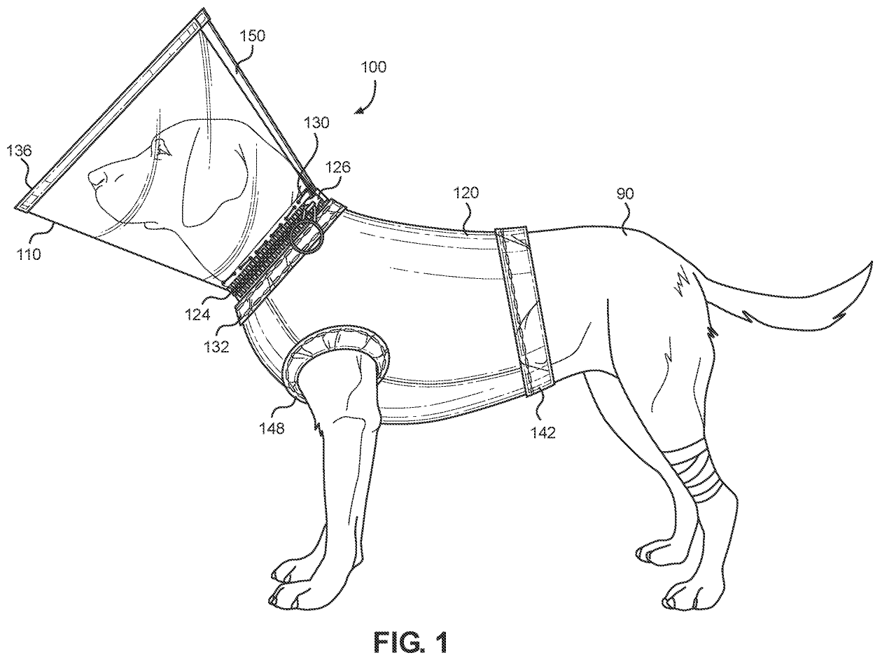

Referring initially to FIG. 1, a right side view of a dog 90 wearing a preferred embodiment of a protective collar attachment system 100 is illustrated. Protective collar attachment system 100 provides a protective collar, hereinafter referred to as cone 110, that is used by securing cone 110 to a cone attachment garment 120. Cone 110 is secured to garment 120 using a fastener. As illustrated in FIG. 1, a preferred embodiment of fastener is a zipper 124 with a slider 126 engageable to close the zipper 124, securing cone 110 to garment 120, or to open the zipper 124 to remove cone 110 from garment 120. In a preferred embodiment, one side of zipper 124 is attached to base 130 of cone 110, while the other side of zipper 124 is attached to collar 132 of garment 120.

Preferred embodiments of cone 110 include a protective ring 136 around the edge of cone 110 opposite garment 120. A preferred embodiment of protective ring 136 is a rubber rim that serves to mitigate damage when cone 110 collides with an object, person, or other animal, and to protect the wearer by mitigating the acceleration during such a collision. In an alternate embodiment, protective ring 136 is a fabric rim providing similar protection.

Protective collar attachment system 100 is illustrated in use with a dog. Preferred embodiments of protective collar attachment system 100 are particularly useful for dogs and cats, but embodiments for use with other animals are fully contemplated herein.

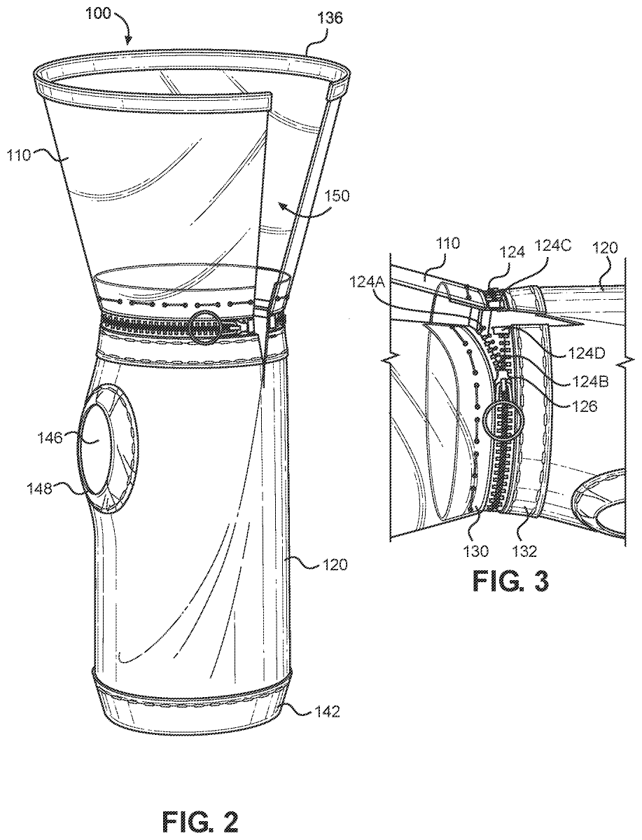

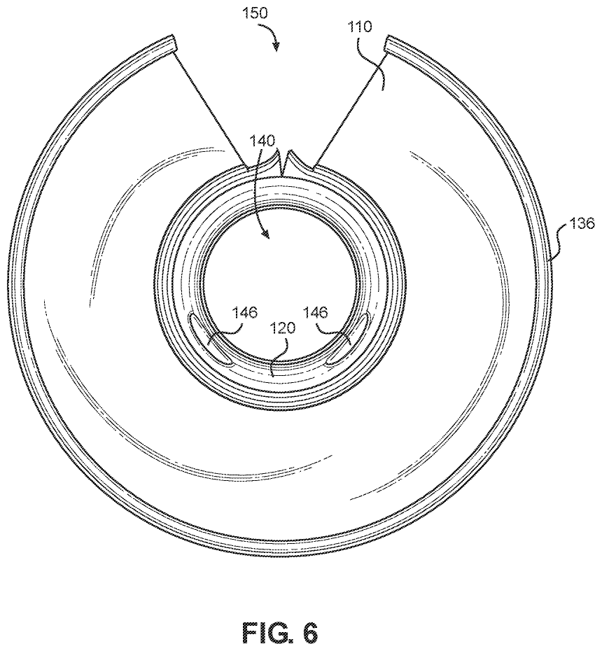

Referring now to FIG. 2, a top perspective view of protective collar attachment system 100 is illustrated. Garment 120 has a rear opening 140 (shown in FIG. 6) opposite garment collar 132. In preferred embodiments, a hem 142 around rear opening 140 encloses an elastic band (not illustrated) that provides a secure yet comfortable fit for the wearer of garment 120. Similarly, two armholes 146 for the frontal or upper limbs of the wearer have hems 148 around their circumferences, with the hems 148 enclosing elastic bands (not illustrated) that comfortably secure the fit of garment 120 around the wearer's frontal or upper limbs. It will be apparent to one of ordinary skill in the art that elastic bands can be attached to the garment 120 other than through hems 142 and 148, such as by attaching knitted elastic directly on the outside of the body of garment 120; embodiments attaching elastic bands other than through encasement in hems are fully contemplated herein. Moreover, other preferred embodiments use stretchable fabric such as jersey cotton or spandex to finish rear opening 140 and armholes 146.

For further ease of attachment, cone 110 has a cone opening 150 tapering down from its widest point at the edge of cone 110 at protective ring 136, and in some preferred embodiments extending into garment 120 and terminating near garment collar 132, that is, substantially closer to garment collar 132 than to the end of garment 120 opposite garment collar 132.

Referring now to FIG. 3, zipper 124 is illustrated in a partially open configuration, showing how cone 110 can be attached and removed from garment 120. Side 124A (the “cone side”) of zipper 124 is attached to the base 130 of cone 110, while side 124B of zipper 124 is attached to garment collar 132 of garment 120. By engaging slider 126 to separate the teeth of zipper 124 until all the teeth are separated, cone 110 can be removed from garment 120. To reattach cone 110 to garment 120, cone 110 is placed around the wearer's head, retainer box 124C of zipper 124 is used to align the pins of zipper 124, and slider 126 is engaged to join the pins of zipper 124 until all the pins are joined when the slider 126 reaches stop 124D.

In a preferred embodiment, cone 110 is made of clear polycarbonate, allowing sufficient flexibility to facilitate attachment and removal of cone 110 to garment 120, while retaining sufficient rigidity to maintain its general shape and prevent the wearer from biting, scratching, and other harmful behaviors that an Elizabethan collar is intended to prevent.

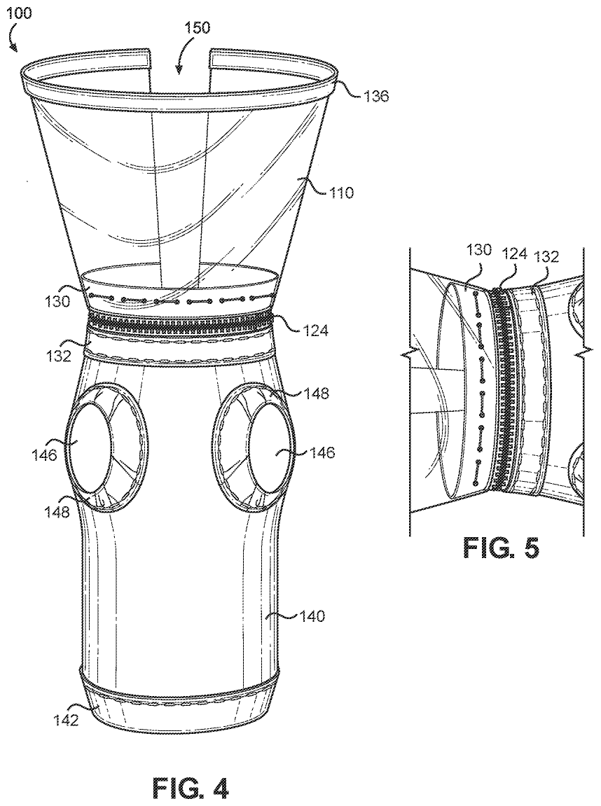

Referring now to FIG. 4, a bottom perspective view of protective collar attachment system 100 is shown. The relative positioning of armholes 146 in a preferred embodiment is illustrated. It will, however, be apparent to one of ordinary skill in the art, that a greater or lesser spacing between the armholes 146 will be appropriate for certain species of animal and certain breeds within a species; such embodiments are fully contemplated herein.

Referring now to FIG. 5, a bottom perspective view of zipper 124 is shown, in which zipper 124 is illustrated in a closed configuration.

Referring now to FIG. 6, a front view of the protective collar attachment system 100 is shown, further illustrating the placement of cone 110, rim 126, cone opening 150, garment 120, armholes 146, and rear opening 140.

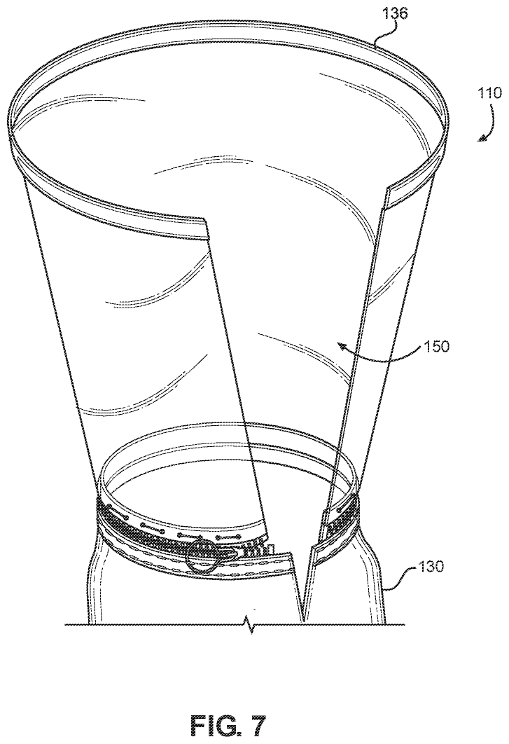

Referring now to FIG. 7, a top perspective view of cone 110 is shown, illustrating cone 110, its attachment to garment 130, rim 136, and cone opening 150, including the extension of cone opening 150 into the front portion of garment 120, as found in a preferred embodiment of protective collar attachment system 100.

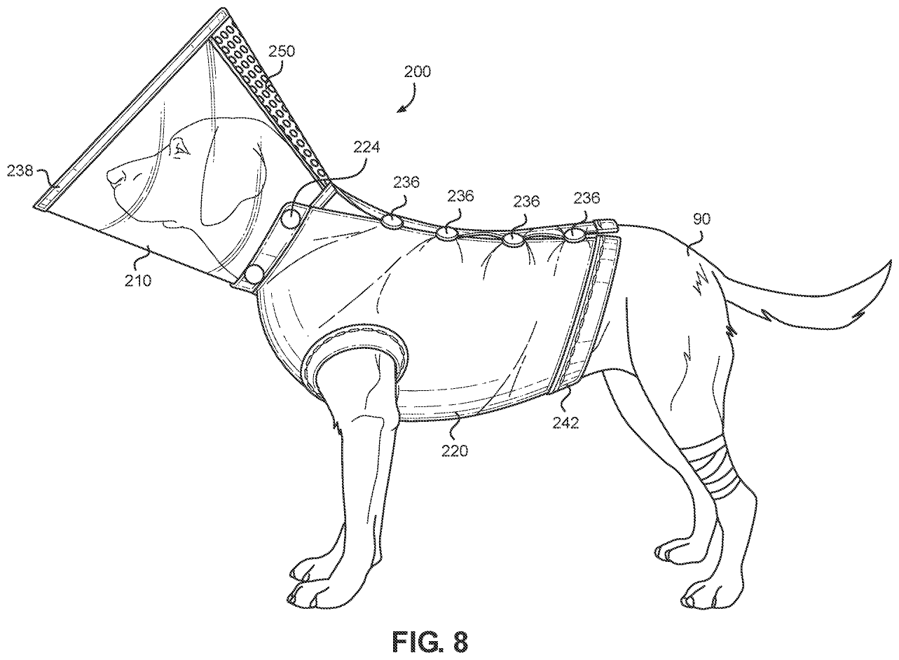

FIGS. 8-12 illustrate variants of an embodiment of a protective collar attachment system in which the cone attachment garment has additional fasteners to facilitate placement of the garment onto an animal and removal of the garment from the animal. Moreover, variations of the cone, the fastener connecting the cone to the garment, and the aforementioned additional garment fasteners are illustrated. It is fully contemplated that any of these features and variations may be added to the embodiment described in connection with FIGS. 1-7, and more generally that the varying features described may be mixed and matched as desired in additional embodiments.

Referring now to FIG. 8, a right side view of a dog 90 wearing an alternate preferred embodiment of a protective collar attachment system 200 is illustrated. Protective collar attachment system 200 provides a protective collar, hereinafter referred to as cone 210, that is used by securing cone 210 to a cone attachment garment 220. Cone 210 is secured to garment 220 using fasteners 224. A preferred embodiment of fasteners 224 are snap fasteners; an alternate embodiment are buttons.

Preferred embodiments of cone 210 include a protective ring 238 around the edge of cone 210 opposite garment 220. A preferred embodiment of protective ring 238 is a rubber rim that serves to mitigate damage when cone 210 collides with an object, person, or other animal, and to protect the wearer by mitigating the acceleration during such a collision. In an alternate embodiment, protective ring 238 is a fabric rim providing similar protection.

Garment 220 has fasteners 236 to facilitate placing garment 220 onto an animal and removing garment 220 from the animal as necessary. As illustrated in FIG. 8, a preferred embodiment of fasteners 236 are snap fasteners. An alternate embodiment of fasteners 236 are buttons.

Protective collar attachment system 200 is illustrated in use with a dog. Preferred embodiments of protective collar attachment system 200 are particularly useful for dogs and cats, but embodiments for use with other animals are fully contemplated herein.

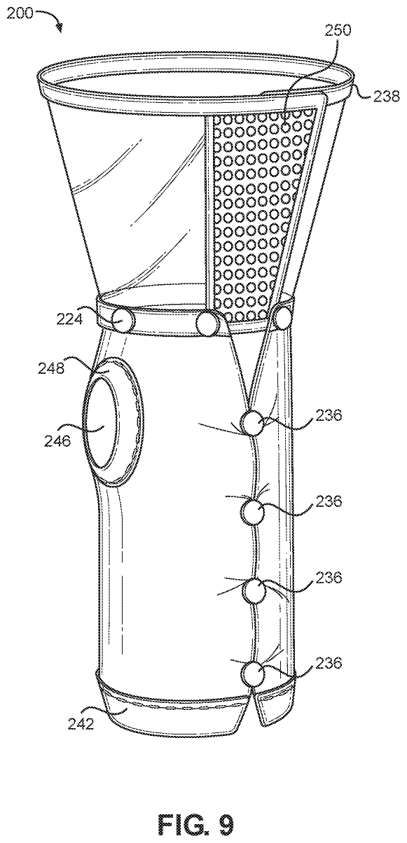

Referring now to FIG. 9, a top perspective view of protective collar attachment system 200 is illustrated. Garment 220 has a rear opening opposite garment collar 232. In some embodiments, a hem 242 around the rear opening encloses an elastic band (not illustrated) that provides a secure yet comfortable fit for the wearer of garment 220. Similarly, preferred embodiments of two armholes 246 for the frontal or upper limbs of the wearer have hems 248 around their circumferences, with the hems 248 enclosing elastic bands (not illustrated) that comfortably secure the fit of garment 220 around the wearer's frontal or upper limbs. It will be apparent to one of ordinary skill in the art that elastic bands can be attached to the garment 220 other than through hems 242 and 248, such as by attaching knitted elastic directly on the outside of the body of garment 220; embodiments attaching elastic bands other than through encasement in hems are fully contemplated herein. Moreover, other preferred embodiments use stretchable fabric such as jersey cotton or spandex to finish armholes 246 and the rear opening.

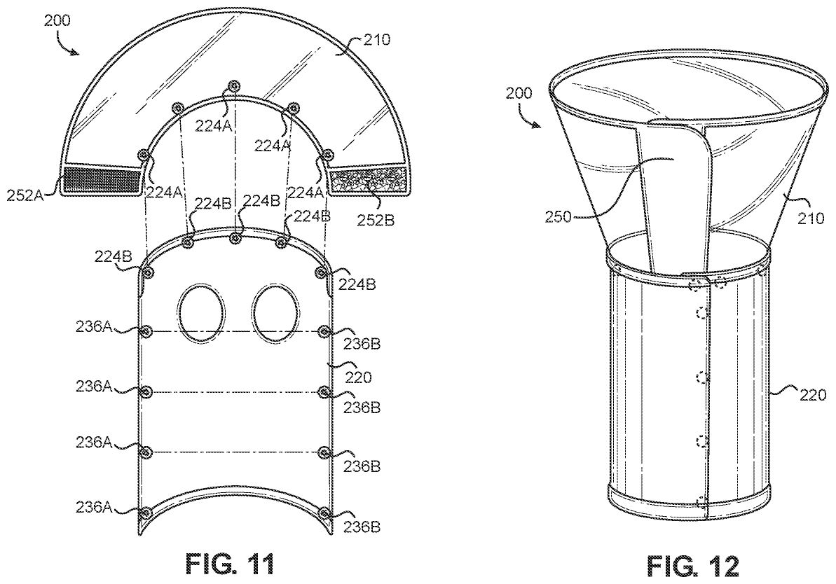

As illustrated in FIG. 9, a preferred embodiment of cone 210 has a top section 250 that partially overlaps the opposite edge of cone 210, avoiding the presence of a cone opening 150, and securing cone 210 in a closed configuration as further illustrated in FIGS. 11 and 12 below.

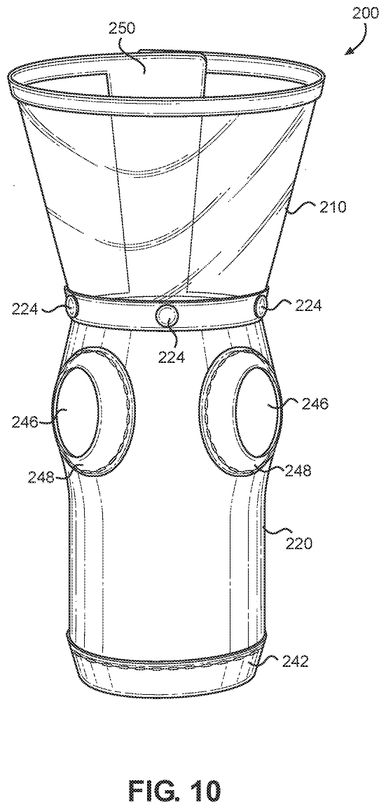

Referring now to FIG. 10, a bottom perspective view of protective collar attachment system 300 is shown. The relative positioning of armholes 146 in a preferred embodiment is illustrated. It will, however, be apparent to one of ordinary skill in the art, that a greater or lesser spacing between the armholes 146 will be appropriate for certain species of animal and certain breeds within a species; such embodiments are fully contemplated herein.

Referring now to FIG. 11, a diagram of protective collar attachment system 200 is illustrated in an unassembled configuration. A preferred embodiment of fasteners 224 are snap fasteners and are made up of male halves 224A that are removably attachable to female halves 224B in order to attach cone 210 to garment 220.

Cone 210 is illustrated in an open configuration, and, in a preferred embodiment, can be secured in a closed configuration through the use of hook-and-loop fasteners, such as those sold in connection with the trademark VELCRO. Embodiments that use other fastener types are also fully contemplated. The hook-and-loop fastener includes a hook end 252A on top section 250 and a loop end 252B on the opposite end of cone 210. In order to illustrate the relative positions of the ends of the hook-and-loop fastener on opposing ends of cone 210, both hook end 252A and loop end 252B are illustrated; however, hook end 252A is on the opposite surface of cone 210 from loop end 252B in order to allow hook end 252A to come into contact with loop end 252B when cone 210 is rolled into its closed configuration as illustrated in FIG. 12.

A preferred embodiment of fasteners 236 are snap fasteners, and are made up of male halves 236A that are removably attachable to female halves 236B in order to secure garment 220 in its closed configuration. In order to illustrate the relative positions of the halves of the fasteners 236 on opposite sides of garment 220, both male halves 236A and female halves 236B are illustrated; however, the female halves 236B are on the opposite surface of garment 220 from the male halves 236A in order to allow the male halves 236A and the female halves 236B to engage to secure the garment 220 into its closed configuration as illustrated in FIG. 12.

Referring now to FIG. 12, protective collar attachment 300 is illustrated in a fully assembled configuration. As illustrated in FIG. 8, fasteners 224 and fasteners 236 can be attached to garment 220 so that the top outer surface (known in the industry as “caps”) of the fasteners 224 and 236 are visible. FIG. 12 illustrates an alternate embodiment in which the caps of fasteners 224 and 236 are not visible on the outside of garment 220, so that the fasteners 224 and 236 are generally not visible while garment 220 is in its closed configuration with cone 210 attached.

It will be apparent to one of ordinary skill in the art that the features of the various embodiments illustrated can be added to the other illustrated embodiments, and features that differ between embodiments can in each case be replaced by the corresponding feature of another embodiment without departing from the scope and spirit of the invention; such modifications are fully contemplated herein.

While there have been shown what are presently considered to be preferred embodiments of the present invention, it will be apparent to those skilled in the art that various changes and modifications can be made herein without departing from the scope and spirit of the invention.

What is claimed is:

1. A protective collar system, comprising:
a protective collar; and
an attachment garment configured to be secured to an animal,
wherein the protective collar is configured to removably attach to the attachment garment.

2. The protective collar system of claim 1, wherein the collar comprises an inner edge where the collar attaches to the attachment garment, and an outer edge opposite the inner edge, and wherein the outer edge has a protective ring.

3. The protective collar system of claim 2, wherein the protective ring is a rubber rim.

4. The protective collar system of claim 1, wherein the protective collar is configured to removably attach to the attachment garment by a zipper.

5. The protective collar system of claim 1, wherein the protective collar is configured to removably attach to the attachment garment by snap fasteners.

6. The protective collar system of claim 1, wherein the protective collar comprises a top section configured to partially overlap another portion of the protective collar to secure the protective collar in a closed configuration.

7. The protective collar system of claim 1, wherein the attachment garment comprises fasteners configured to facilitate placement of the attachment garment onto an animal and removal of the attachment garment from the animal.

8. The protective collar system of claim 7, wherein the fasteners of the attachment garment are not visible while the attachment garment is in a closed configuration.

9. A protective collar system, comprising:
a garment configured for placement on an animal and having an attachment end proximate the animal's neck, and a rear end opposite the attachment end; and
a cone-shaped collar having an attachment end configured to removably attach to the attachment end of the garment and a cone edge opposite the attachment end,
wherein the collar extends forward at least partly around the animal's head when attached to the garment such that the collar prevents self-injury by the animal.

10. The protective collar system of claim 9, wherein the collar comprises a protective ring at the cone edge.

11. The protective collar system of claim 9, wherein the collar is attached to and removed from the garment by engaging a collar attachment fastener.

12. The protective collar system of claim 11, wherein the collar attachment fastener comprises a zipper.

13. The protective collar system of claim 11, wherein the collar attachment fastener comprises snap fasteners.

14. The protective collar system of claim 11, wherein the collar comprises clear polycarbonate.

15. The protective collar system of claim 11, wherein the collar comprises a cone opening at a top portion of the collar, and wherein the garment comprises an extension of the cone opening.

16. The protective collar system of claim 11, wherein the collar comprises a top section configured to partially overlap another portion of the collar to secure the collar in a closed configuration.

17. The protective collar system of claim 11, wherein the garment comprises fasteners configured to facilitate placement of the garment onto an animal and removal of the garment from the animal.

18. The protective collar system of claim 17, wherein the fasteners of the garment are not visible while the garment is in a closed configuration.

19. The protective collar system of claim 10, wherein the garment comprises two armholes configured to secure the garment around frontal limbs of the animal and a rear opening at the rear end.

20. The protective collar system of claim 19, wherein the armholes and the rear opening are finished with a stretchable fabric.
